(19) United States
(12) Patent Application Publication
(10) Pub. No.: US 2009/0293331 A1
(43) Pub. Date: Dec. 3, 2009

(54) GRAPHIC DISPLAY FRAME SYSTEM

(75) Inventor: Matthias D. Kemeny, Vancouver, WA (US)

Correspondence Address: MARGER JOHNSON & MCCOLLOM, P.C., 210 SW MORRISON STREET, SUITE 400, PORTLAND, OR, 97204, US

(73) Assignee: Idea Development Company, Vancouver, WA (US)

(21) Appl. No.: 11/559,719

(22) Filed: Nov. 14, 2006

(51) Int. Cl. G09F 15/00; G09F 15/02; G09F 7/00

(52) U.S. Cl. 40/610; 40/611.01

(57) ABSTRACT

A display frame system includes a foot having an arm attachment point and two or more rod attachment points located at different distances from the arm attachment point. The foot may include a second arm attachment point opposite the first attachment point to enable a two-sided display having multiple configurations with one or two upright rods. The arm attachment points may include socket bodies having multiple sockets offset from a centerline of the foot to prevent the rods from interfering with each other at a crossover point. An insert for attaching a graphic sheet to a display arm has a cross section with a first portion extending to an enlarged end to engage a slot in the display arm, and a second portion extending away from the first portion to engage a first side of the graphic sheet. A third portion may engage a second side of the graphic sheet, with both portions having adhesive to bond with the sheet.

### BACKGROUND

FIG. 1 illustrates a prior art graphic display frame for trade shows, interpretive exhibits, and the like. The frame includes a foot 10 having a crossarm 12 attached at one end. The foot has a socket located near the other end to receive one end of a flexible rod 14. The other end of the flexible rod is attached to a second crossarm 16. A graphic sheet 18 is stretched between the two crossarms, and the length of the rod is selected so that it flexes gently to keep the graphic sheet pulled tight between the crossarms.

FIG. 2 illustrates the manner in which the lower crossarm is attached to the foot of FIG. 1. Referring to FIG. 2, the foot 10 is made from an aluminum extrusion having an inverted T-shape cross-section. A passageway 20 in the foot acts as a socket to receive a connector 22 that is attached to the crossarm with a screw 24. A cylindrical recess 26 is formed in the end of the foot to allow the foot to more closely engage the cylindrical surface of the crossarm when the connector 22 is inserted into the passageway.

FIG. 3 is a cross-sectional view that illustrates how the upper and lower crossarms 12 and 16 engage the graphic sheet 18. The end of the sheet is wrapped around a rod 28 and folded back on itself to form a hem 30 and a cylindrical bead 32. Each crossarm is made from an aluminum extrusion and has a cylindrical cross-section with a slot 34 that allows the graphic sheet and bead to slide in along the axis of the crossarm. The diameter of the rod is large enough to prevent the bead from slipping out through the slot when the graphic sheet is pulled tight between the crossarms. A countersunk recess 36 accommodates the head of a screw which may be used to attach the crossarm to connector 22 of FIG. 2, or the top of the flexible rod 14 of FIG. 1.

Although the display frame illustrated in FIGS. 1-3 performs admirably in some situations, there is still room for improvement. For example, the hemmed bead at the end of the graphic sheet is difficult and costly to form, and it does not tolerate misalignment of the sheet very well. As a further example, the foot is expensive to fabricate from an extrusion, and it requires machining operations at both ends to form the cylindrical recess for the lower crossarm, as well as the socket for the flex rod. Moreover, as the trade show industry becomes more competitive, exhibitors are seeking better ideas for products that are more versatile and provide visual impact to help them stand out in a crowded forum.

### BRIEF DESCRIPTION OF THE DRAWINGS

FIG. 1 illustrates a prior art graphic display frame.

FIG. 2 illustrates the manner in which the crossarm and foot of FIG. 1 are attached.

FIG. 3 is a cross-sectional view that illustrates how the crossarms engage the graphic sheet of FIG. 1.

FIG. 4 illustrates an embodiment of a foot for a graphic display frame according to some of the inventive principles of this patent disclosure.

FIG. 5 is an enlarged view of a portion of the foot of FIG. 4.

FIG. 6 is a top view of the foot of FIG. 4.

FIG. 7 is an enlarged view of another portion of the foot of FIG. 4.

FIGS. 8 and 9 illustrate perspective and side views of an embodiment of a graphic display frame according to some additional inventive principles of this patent disclosure.

FIGS. 10 and 11 illustrate perspective and side views of another embodiment of a graphic display frame according to some additional inventive principles of this patent disclosure.

FIGS. 12 and 13 illustrate perspective and side views of yet another embodiment of a graphic display frame according to some additional inventive principles of this patent disclosure.

FIGS. 14-18 illustrate an embodiment of an insert for attaching a graphic sheet to a display arm according to some additional inventive principles of this patent disclosure.

### DETAILED DESCRIPTION

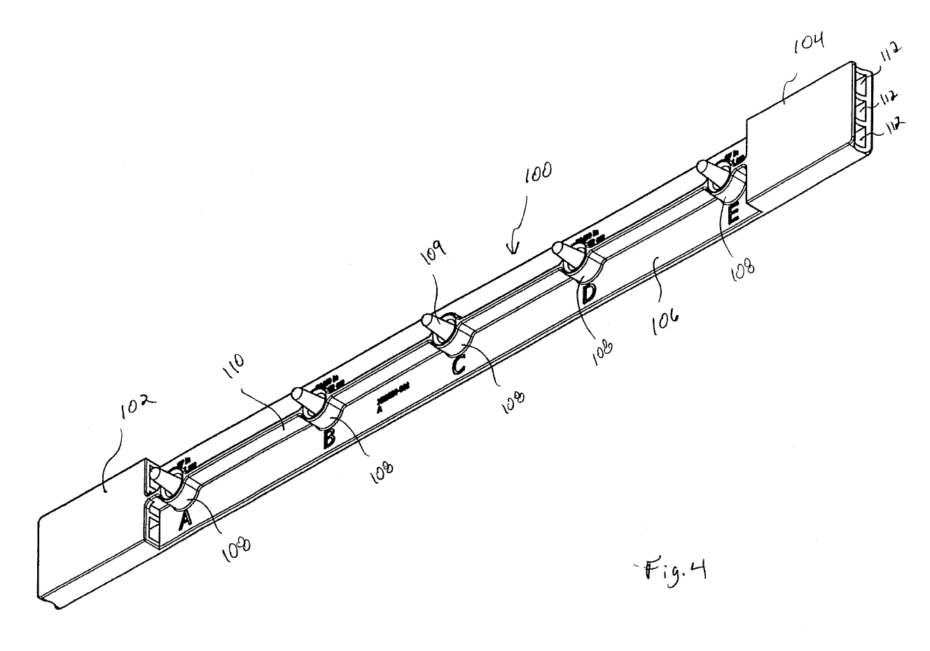

FIG. 4 illustrates an embodiment of a foot for a graphic display frame according to some of the inventive principles of this patent disclosure. The foot 100 of FIG. 4 has a first socket body 102 at one end and a second socket body 104 at the other end. The socket bodies are connected by a flat base plate 106 and provide attachment points for crossarms at either end of the foot. The foot also includes a series of upright sockets 108 that are spaced along the base plate at different distances from the socket bodies. The upright sockets 108 provide different attachment points for one or more flexible rods. A spine 110 runs along the axis of the foot, connecting the socket bodies and the upright sockets, and stiffening the foot.

The upright sockets may include guides to facilitate insertion of a rod into the socket. In the embodiment of FIG. 4, the guides are shown as cones 109 that are centered in, and extend above the rims of, the sockets to guide hollow rods into the sockets. In the embodiment of FIG. 4, five upright sockets designated A-E are shown, but other numbers of sockets may be used.

The socket bodies 102 and 104 have multiple sockets 112 formed from passageways that may be located at different positions relative to the centerline of the foot. Thus, the crossarm may be laterally offset from the centerline of the foot depending on which socket the crossarm connector is inserted into.

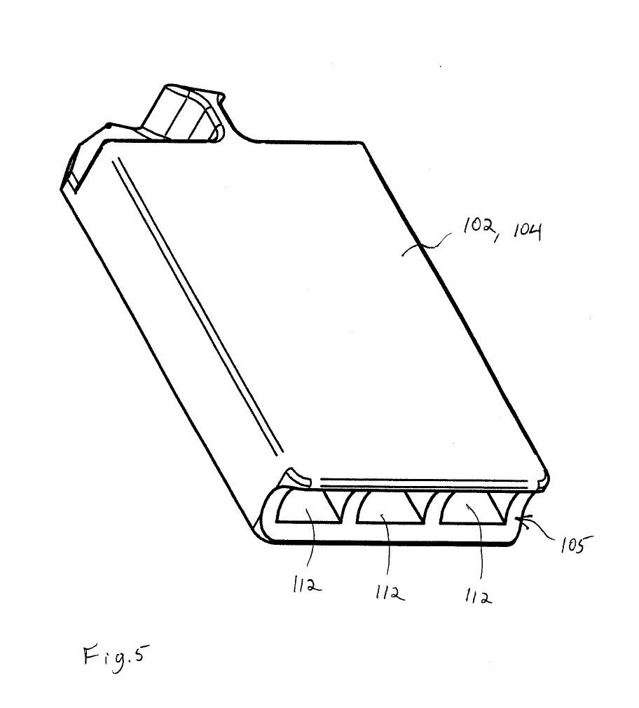

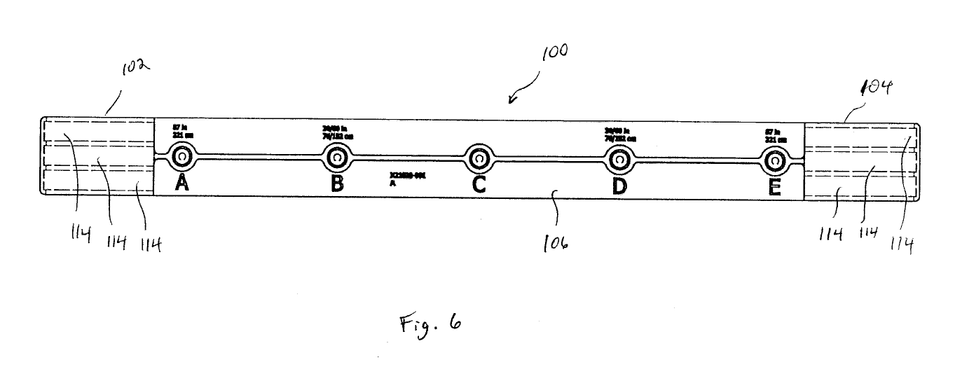

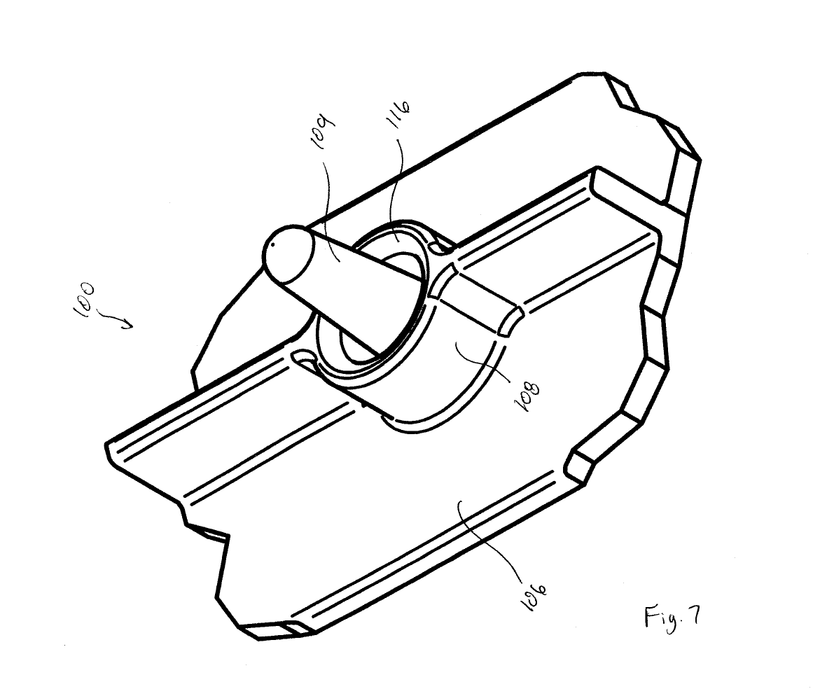

FIG. 5 is an enlarged view of either socket body 102,104. The front of the socket body has a concave surface 105 having a cylindrical axis arranged perpendicular to the axis of the foot to enable the socket body to more closely engage the outer cylindrical surface of a crossarm. FIG. 6 is a top view of foot 100 showing the passageways 114 that form the sockets in broken lines. FIG. 7 is an enlarged view of one of the upright sockets 108 showing a chamfered inner rim 116 that helps guide a pole into the socket.

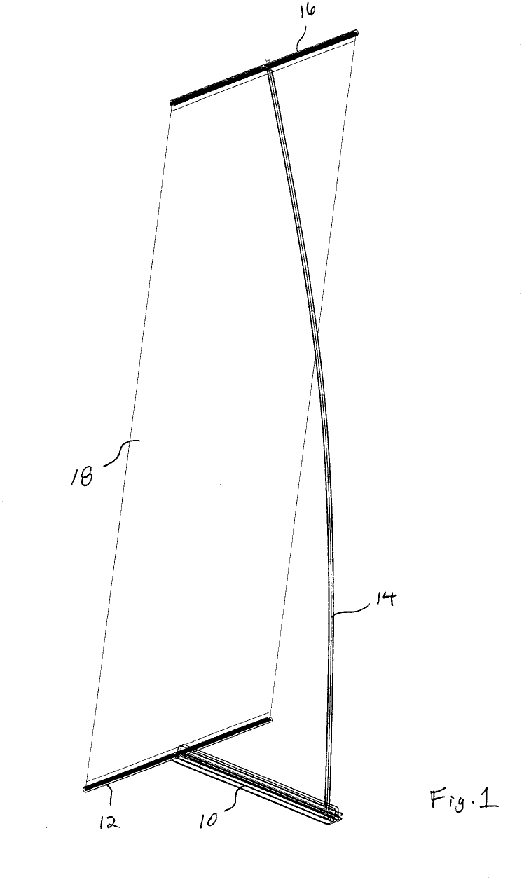

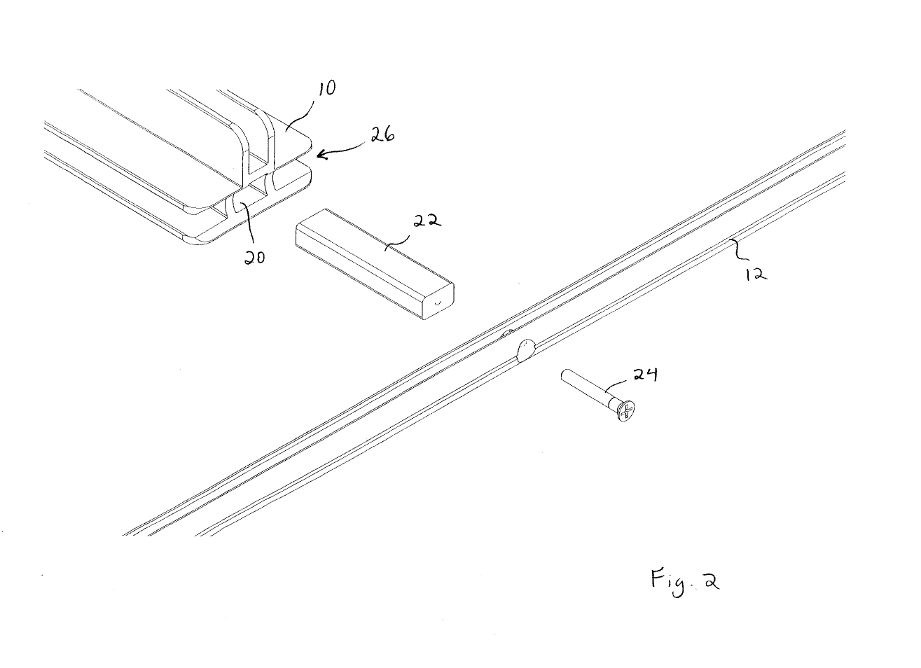

The graphic display foot illustrated in FIGS. 4-7 may provide numerous advantages when substituted for the extruded aluminum foot shown in FIG. 1. For example, it can be readily manufactured with molded plastic, thereby reducing the cost and weight of the foot. Its multiple upright sockets provide greater flexibility in positioning the flexible rod to accommodate graphic sheets of different heights. According to some additional inventive principles of this patent disclosure, the flexible rod may be assembled from modular sections depending on the height of the graphic sheet, and then inserted into whichever upright socket provides the best aspect ratio for the fame. When substituted into a conventional frame configuration of FIG. 1, one of the socket bodies can be eliminated.

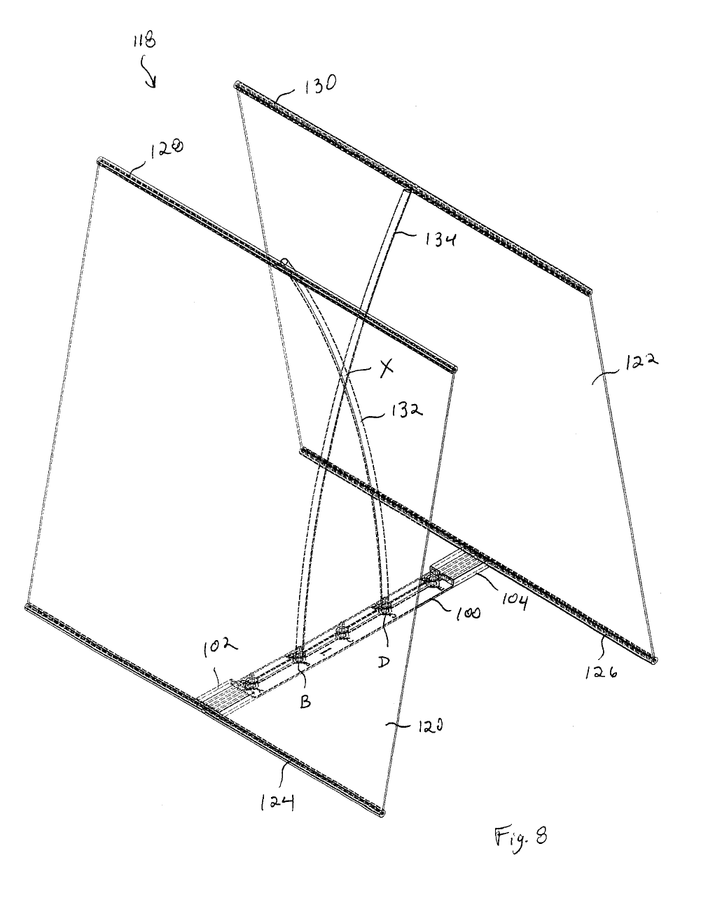

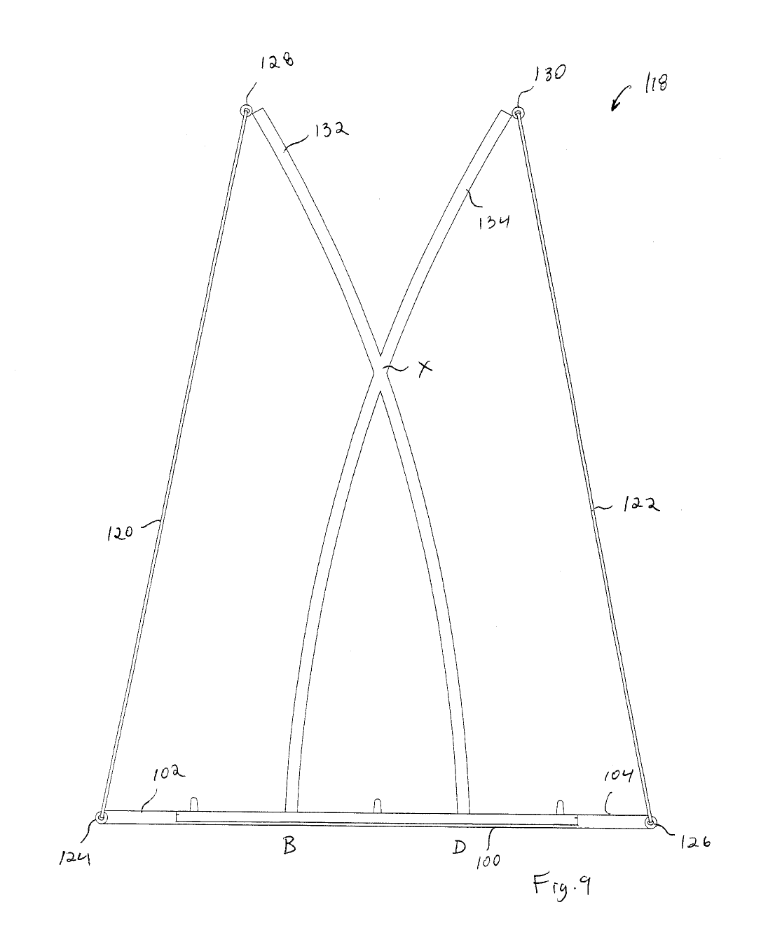

Not only does the graphic display foot of FIGS. 4-7 improve the conventional graphic display frame configuration, but it also enables additional novel frame configurations. For example, FIGS. 8 and 9 illustrate perspective and side views of an embodiment of a graphic display frame 118 according to some additional inventive principles of this patent disclosure. In this embodiment, two relatively short graphic sheets 120 and 122 are arranged in a two-sided configuration. Lower crossarms 124 and 126 are attached at opposite ends of the foot 100. Upper crossarms 128 and 130 are supported by flexible rods 132 and 134. In this configuration, upright sockets B and D may provide the best attachment points for the rods due to the relatively short length of the rods and graphic sheets. Because the socket bodies 102 and 104 have multiple sockets, one or both of the lower crossarms can be offset laterally relative to the centerline of the foot by inserting the connector for the crossarm into the appropriate socket. This may prevent distortion of the fame by eliminating interference between the flexible rods where they intersect at X.

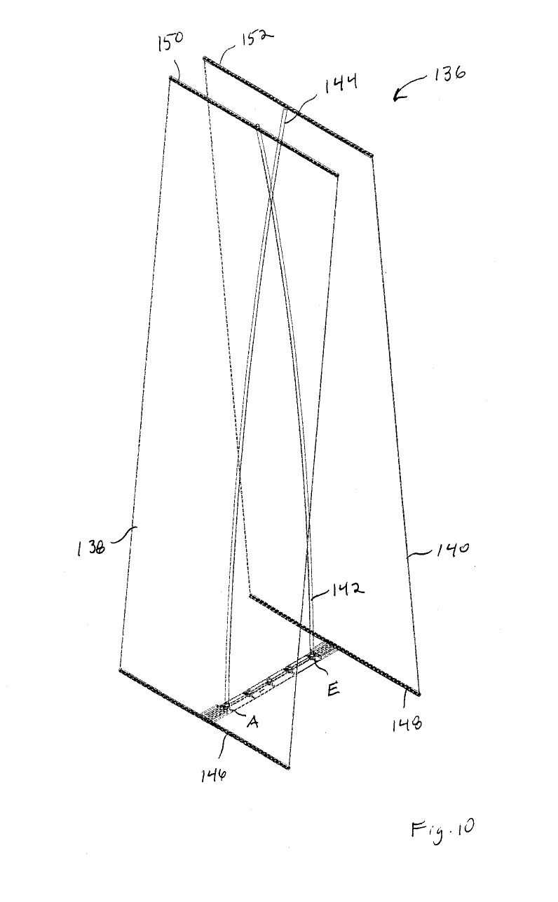

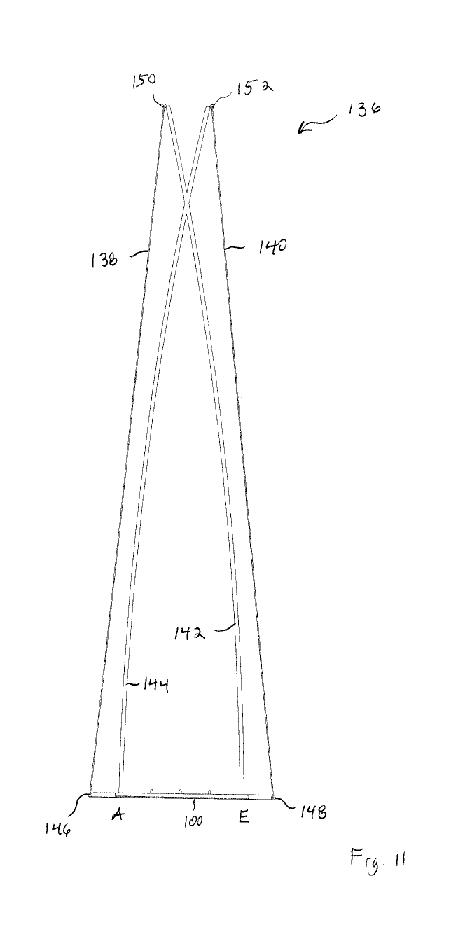

FIGS. 10 and 11 illustrate perspective and side views of another embodiment of a graphic display frame 136 according to some additional inventive principles of this patent disclosure. In this embodiment, which is also two-sided, the graphic sheets 138 and 140 and rods 142 and 144 are substantially longer. The crossarms 146-152 are arranged similar to the embodiment of FIGS. 8 and 9, but due to the greater height of the display, the rods are inserted into sockets A and E to maintain the proper aspect ratio.

According to some additional inventive principles of this patent disclosure, the flexible rods 142 and 144 may be assembled from modular sections depending on the height of the graphic sheets, and then inserted into whichever upright sockets provide the best aspect ratio for the fame.

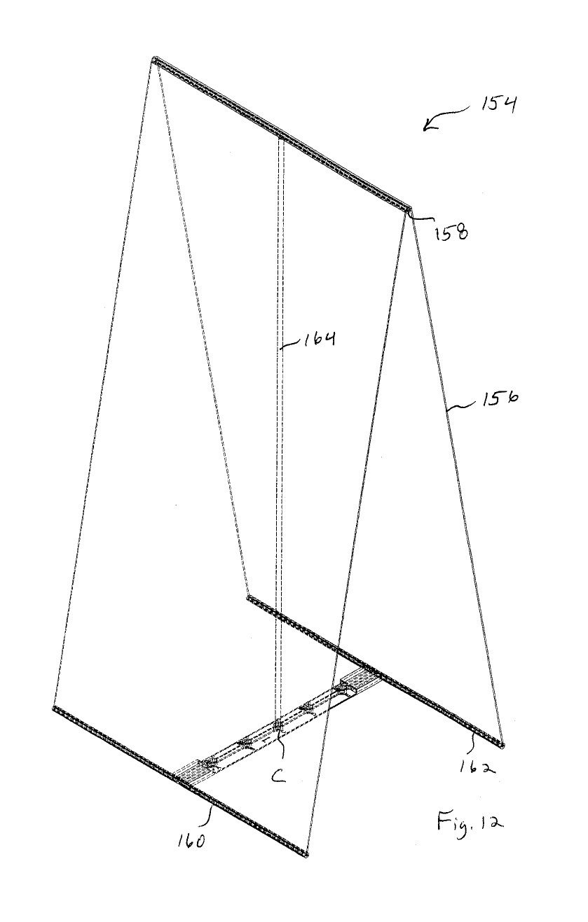

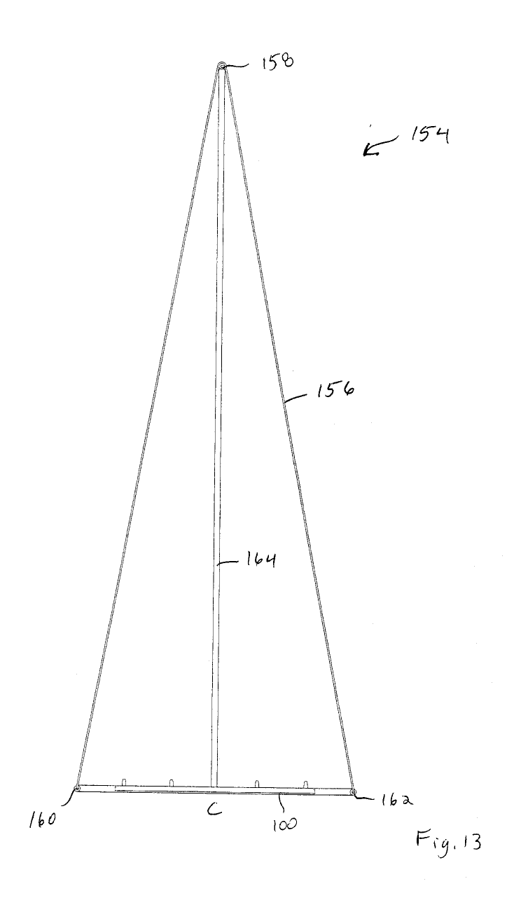

FIGS. 12 and 13 illustrate perspective and side views of another embodiment of a graphic display frame 154 according to some additional inventive principles of this patent disclosure. In this embodiment, a two-sided display is achieved using a single graphic sheet 156 folded over a single upper crossarm 158 in an A-frame configuration. The sheet is anchored at either end by lower crossarms 160 and 162. The rod 164 is attached to the foot at the center socket designated as C. Other configurations are possible.

From the example embodiments described above, it is apparent that a foot for a graphic display frame constructed according to the inventive principles of this patent disclosure may form the basis of an entire display frame system that provides a powerful and flexible solution for many graphic display applications. The foot, crossarms and upright rods (whether monolithic or modular) may be provided individually or as a kit to enable myriad display configurations, and to release the user's creativity to develop yet more configurations.

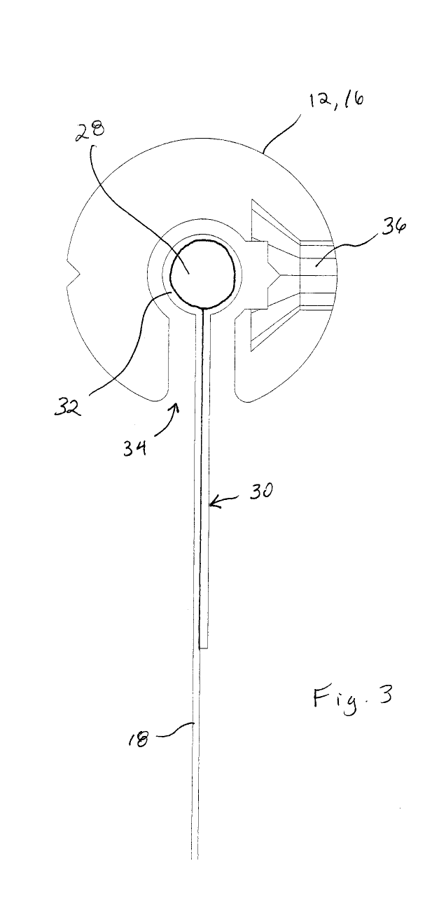

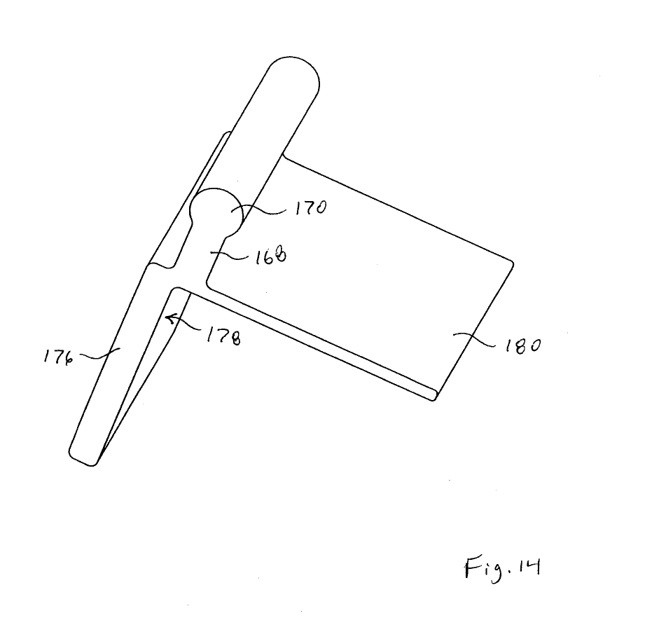

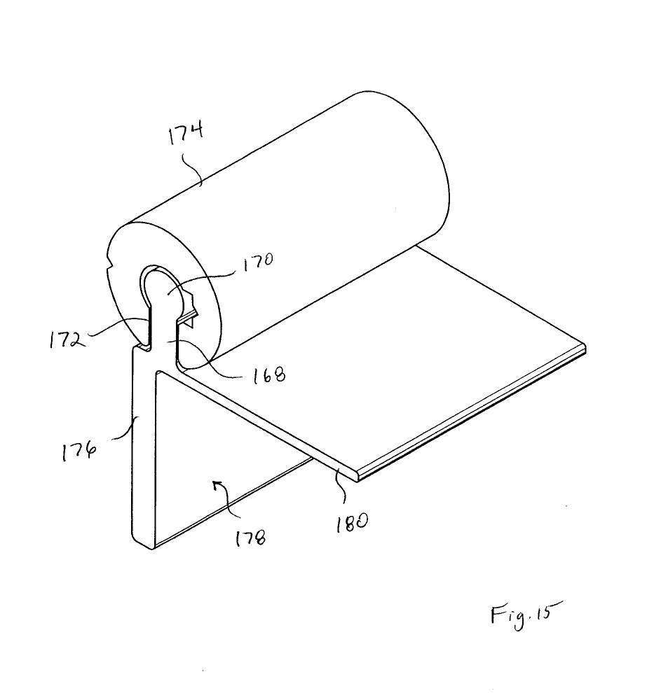

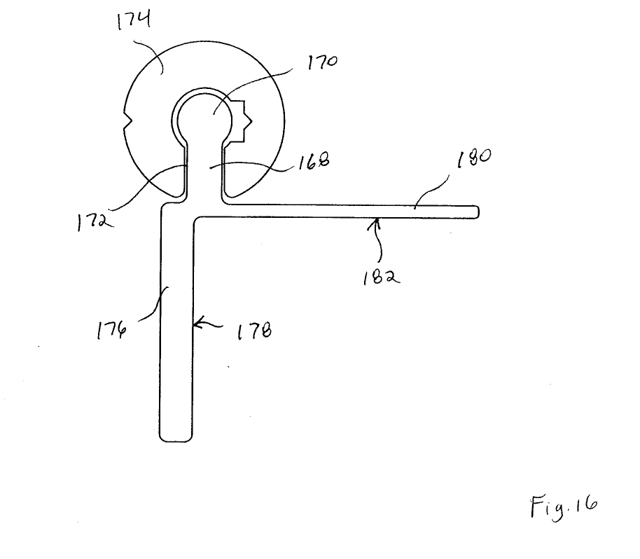

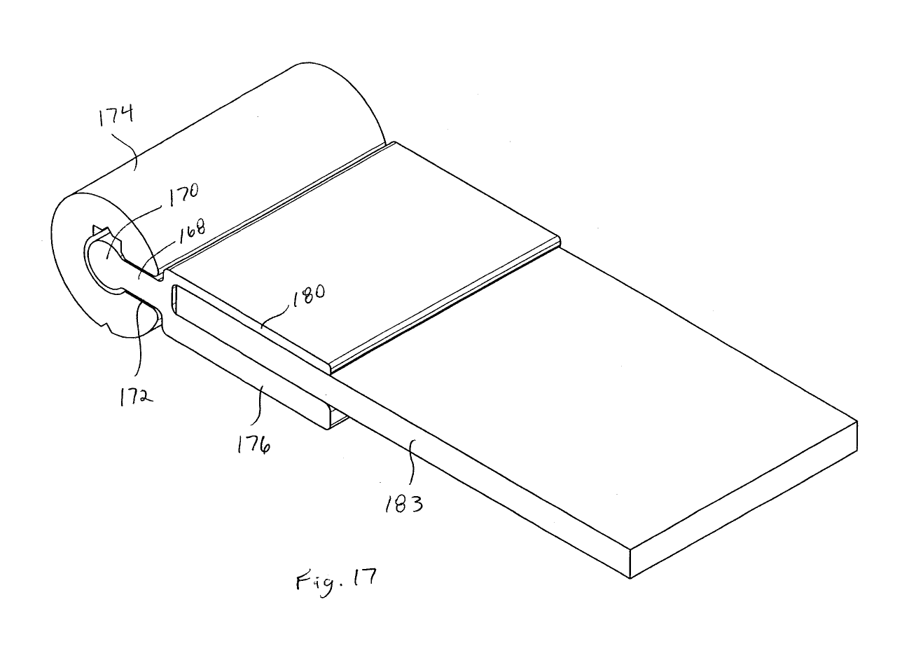

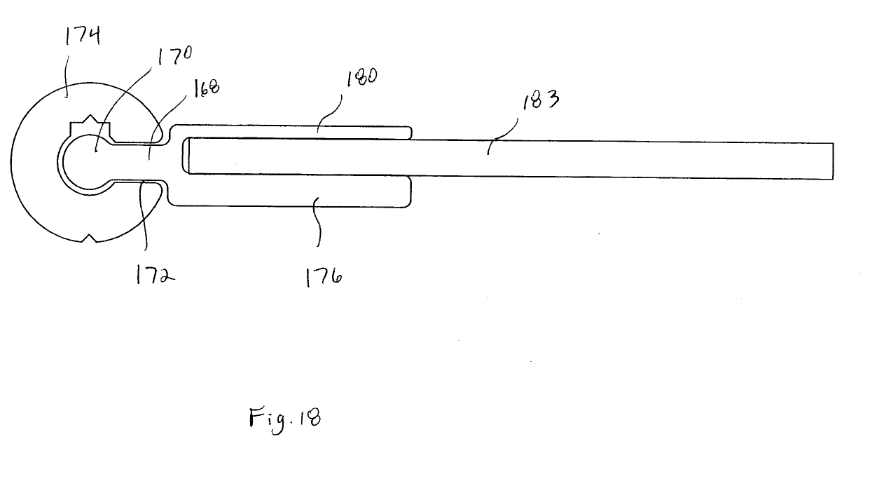

Some additional inventive principles of this patent disclosure relate to an insert for attaching a graphic sheet to a display arm. FIGS. 14-18 illustrate an embodiment of an insert that can replace the prior art hemmed bead shown in FIG. 3. The insert, shown in isolation in FIG. 14, has a cross section that includes a first portion 168 forming a strip that extends to an enlarged end 170 that forms a bead shaped to engage a slot 172 in a display arm 174 as shown in FIGS. 15 and 16. A second portion, 176 forms a strip that extends away from the first portion and has a contact surface 178 against which a graphic sheet may be positioned. A third portion 180 forms another strip that initially extends away from the first and second portions and includes a contact surface 182 as shown in FIG. 16. Once a graphic sheet 183 is placed against the first strip 176, the second strip 180 may be folded towards the first strip so that each side of the graphic sheet engage is engaged by one of the contact strips as shown in FIGS. 17 and 18.

In some embodiments, one or both of the contact surfaces 178 and 182 may be coated with a pressure sensitive adhesive to form a secure bond between the graphic sheet and the insert as the graphic sheet is squeezed between the contact strips. Protective peel-off strips may be applied over the adhesive to protect the adhesive prior to use. In other embodiments, one of the contact strips may be eliminated and the graphic sheet may be attached to the remaining strip with adhesive, hook and loop fasteners, etc. In still other embodiments, the second contact strip may not be foldable, but may simply form a U-shaped cross-section with the first strip. In this case, the graphic sheet may be inserted into the slot between the strips and fastened with adhesive, or by driving staples or rivets through the strips, or by any other suitable fastening technique.

The insert 166 may be slid into the display arm 174 prior to or after attaching the sheet 183, whichever is more convenient. The insert may be formed of any suitable material such as molded or extruded metal or plastic. In some embodiments, the insert may be long enough to span the entire length of the display arm and/or graphic sheet, while in other embodiments, the inserts may be implemented as short sections at the ends of the display arm or spaced as various points along the arm.

An insert constructed according to the inventive principles of this patent disclosure may have numerous advantages over the prior art. For example, it may be more tolerant of misalignment of the graphic sheet, especially if it is made from a ductile material that has certain amount of flexibility. It may reduce the cost, time and complexity of assembling a graphic display by eliminating the specialized skills and apparatus required to form a hemmed bead. It may also provide the user with more flexibility to create displays on short notice to accommodate rapidly changing requirements at trade shows and other events.

The inventive principles relating to inserts can be utilized independently of the inventive principles relating to display frames discussed above, and vice versa. That is, an insert according to the inventive principles of this patent disclosure can be used beneficially with a prior art display frame, and the inventive display frames can be used beneficially with prior art hemmed graphic sheets. However, the principles may also be combined synergistically to provide a versatile system for creating graphic displays. Armed with an assortment of display feet, crossarms, modular upright rods and inserts according to the inventive principles of this patent disclosure, an exhibitor can travel to a trade show with confidence knowing that these components can be used to create a vast array of displays using any available graphic sheets such as paper, cloth, polymer film, etc. that may be run through a computer printer, or obtained from local vendors.

The inventive principles of this patent disclosure have been described above with reference to some specific example embodiments, but these embodiments can be modified in arrangement and detail without departing from the inventive concepts. For example, some embodiments have been illustrated with specific numbers of attachment points for crossarms, upright rods, etc., but other numbers can be used. Some display frame components have been described as being crossbars attached to a single upright rod, but multiple rods maybe utilized, and other types of display bars are contemplated within the inventive principles. Some attachment points have been illustrated as being implemented with rods or connectors that are inserted into sockets, but other attachment mechanism may be utilized. Such changes and modifications are considered to fall within the scope of the following claims.

1. A display frame system comprising a foot having:
an arm attachment point; and
two or more rod attachment points located at different distances from the arm attachment point.

2. The system of claim 1 where the arm attachment point is a first arm attachment point located at a first end of the foot, and the foot further comprises a second arm attachment point located at a second end of the foot opposite the first end.

3. The system of claim 2 where the arm attachment points comprise sockets.

4. The system of claim 2 where the arm attachment points comprise socket bodies having multiple sockets.

5. The system of claim 4 where one or more of the sockets of each socket body is offset from a centerline of the foot.

6. The system of claim 1 where the rod attachment points comprise sockets.

7. The system of claim 6 where the sockets include guides.

8. The system of claim 1 further comprising a modular rod to engage one or more of the rod attachment points.

9. The system of claim 8 further comprising a second modular rod to engage one or more of the rod attachment points.

10. The system of claim 1 further comprising:
a display arm adapted to be attached to the arm attachment point; and
an insert for attaching a graphic sheet to the display arm, the insert having a cross-section comprising:
a first portion extending to an enlarged end to engage a slot in the display arm; and
a second portion extending away from the first portion to engage a first side of the graphic sheet.

11. The insert of claim 10 further comprising a third portion to engage a second side of the graphic sheet.

12. The insert of claim 11 where the third portion has a first position away from the second portion and a second position adjacent to the second portion.

13. The insert of claim 12 where the third portion is pivotally attached to the insert.

14. The insert of claim 10 further comprising adhesive disposed on the second portion to bond with the graphic sheet.

15. The insert of claim 11 further comprising adhesive disposed on the second and third portions to bond with two sides of the graphic sheet.

16. The display frame system of claim 1 further comprising:
a first display arm attached to the foot at the arm attachment point;
a second display arm attached to the foot at a second arm attachment point;
a first pole attached to a first one of the two or more rod attachment points of the foot at a first end of the first pole; and
a third display arm attached to a second end of the first pole.

17. The system of claim 16 further comprising a graphic sheet attached to the first and second display arms, and extending over the third display arm.

18. The system of claim 16 further comprising:
a second pole attached to a second one of the two or more rod attachment points of the foot at a first end of the second pole; and
a fourth display arm attached to a second end of the second pole.

19. The system of claim 18 further comprising:
a first graphic sheet attached between the first and third display arms; and
a second graphic sheet attached between the second and fourth display arms.

20. The system of claim 18 further comprising first through fourth inserts to attach graphic sheets to the first through fourth display arms.
